(19) United States
(12) Patent Application Publication
(10) Pub. No.: US 2002/0007897 A1
(43) Pub. Date: Jan. 24, 2002

(54) MEHTOD AND APPARATUS FOR PROVIDING THROUGH-THE-THICKNESS REINFORCEMENTS IN LAMINATED COMPOSITE MATERIALS

(76) Inventor: GARY L. FARLEY, YORKTOWN, VA (US)

Correspondence Address: NATIONAL AERONAUTICS AND SPACE ADMINISTR, ATION LANGLEY RESEARCH CENTER, 3 LANGLEY BOULEVARD, MAIL STOP 212, HAMPTON, VA, 236812199

(21) Appl. No.: 09/210,339

(22) Filed: Dec. 11, 1998

Related U.S. Application Data
(60) Provisional application No. 60/080,241, filed on Apr. 1, 1998.

(51) Int. Cl. C09J 1/00

(52) U.S. Cl. 156/163

(57) ABSTRACT

Through-the-thickness reinforcement to an uncured laminated composite material is achieved by the use of an impulsive force to drive a rod through the composite material. The small size of the rod helps it provide reinforcement without substantially compromising in-plane mechanical properties. The impulsive force is preferably delivered with a machine that comprises a rod guide for guiding the reinforcing rod into the composite material and a ram with a hardened driving portion face for thrusting the rod along the rod guide.

### CLAIM OF BENEFIT OF PROVISIONAL APPLICATION

Pursuant to 35 U.S.C. Section 119, the benefit of priority from provisional application No. 60/080,241, with a filing date of Apr. 1, 1998, is claimed for this non-provisional application.

### ORIGIN OF THE INVENTION

The invention described herein was made by an employee of the U.S. Government and may be used by or for the government for governmental purposes without the payment of royalties thereon or therefor.

### BACKGROUND OF THE INVENTION

1. Technical Field of the Invention

The present invention is directed to a method and apparatus for reinforcing laminated composite materials. In particular, the reinforcing entails the insertion of rods through the thickness of laminated composite materials.

2. Description of the Related Art

A typical laminated composite material is shown in FIG. 1. The laminated composite material 100 is composed of layers or plies of yarns 110. The yarns 110 are themselves composed of a multitude of fibers 120. The longitudinal axis of each fiber 120 is substantially aligned with the longitudinal axis of the respective yarn 110. In prepreg material, the yarns are pre-impregnated with a resin that will harden when cured. In dry fiber preforms the resinous material has not yet been added. The laminated composite material is usually shaped by laying up prepreg material or dry fiber preforms on a support tool that defines the shape of the desired structure, saturating the voids between the yarns with a resin, and curing the resin to form a structure. The hardened resin forms a matrix 130 that holds the yarns together. The strength of the matrix 130 is much less than the longitudinal strength of the yarns 110. Laminated composite materials 100 are generally made with the yarns 110 in adjacent plies oriented differently. In FIG. 1, the plies have yarn orientations that are rotated 90 degrees with respect to the adjacent plies. The resultant structure has great strength in planes parallel to the plies (the in-plane directions), but are weak in the direction perpendicular to the plies (the interlaminar direction). Other types of laminated composite materials differ in their details, but are still characterized by a matrix material supporting a multitude of fibers oriented substantially parallel to a surface. Specifically, in addition to the dry-fiber preforms and the laid up prepreg material, tow-placed and filament-wound structures are to be considered laminated composite materials herein. Uncured laminated composite material refers to either dry-fiber preforms, laid up prepreg material, tow-placed, filament-wound, or similar fiber-filled materials before the material is cured into a hardened structure, regardless of whether or not the material includes a resinous substance.

Providing through-the-thickness reinforcement in laminated composite materials greatly increases the interlaminar strength, resulting in a more damage-tolerant structure. Under certain conditions through-the-thickness reinforcements also act as miniature crack arresters.

One way of providing through-the-thickness reinforcement consists of stitching the laminates together with yarns. However, Farley and Dickinson [NASA Conference Publication 3176, pp. 123-143, 1992] show that the stitch loop degrades the compressive strength of the resultant material. Tufting is similar to stitching in that a yarn is threaded through the laminates. However, tufting does not leave a stitch loop. When used with prepreg materials both the stitching and tufting processes potentially induce resin-rich regions that can adversely affect structural performance. When stitching and/or tufting is performed on prepreg materials, uncured resin tends to stick to the stitching/tufting needles. This tendency slows the process and results in poor manufacturing economics.

Stitching/tufting has been more successful when applied to dry fiber preforms. However, the process is difficult to use on preforms with compound curvature or those that integrate complex-shaped interconnecting parts. In addition, the need for stitching machinery to access both sides of the preform further complicates the process.

Other techniques have been developed to provide through-the-thickness reinforcing without the need to access both sides of the laminated composite material.

For instance, U.S. Pat. No. 4,808,561 to Boyce et al. describes a process in which reinforcing elements are embedded in a thermally decomposable structure having opposing surfaces. The reinforcing elements extend perpendicular to the opposed surfaces. The thermally decomposable structure is placed on the laminated composite that requires reinforcement and then exposed to elevated temperature and pressure. The thermally decomposable structure collapses under the influence of the elevated temperature and pressure while the reinforcing elements are inserted into the laminated composite. A variation of the process is disclosed in U.S. Pat. No. 5,466,506 to Freitas et al. Here the reinforcing elements are inserted obliquely into the laminated composite. They claim that the obliquely inserted reinforcing elements help prevent against both laminate peeling (mode I failures) and shear-induced (mode II) failures. Both approaches require heat and pressure to insert the reinforcing elements.

Other approaches employ ultrasonic energy to locally heat and soften the composite laminates. In U.S. Pat. No. 5,186,776 to Boyce et al., a reinforcing fiber is fed into an elongated hollow needle that is ultrasonically vibrated and inserted into the composite laminate material. The needle is then retracted, leaving the reinforcing fiber in place. U.S. Pat. No. 5,589,015 to Fusco et al. discloses a hybrid method of inserting through-the-thickness reinforcing elements. A compressible structure with reinforcing elements embedded therein is used in a way similar to the thermally decomposable structure of U.S. Pat. No. 4,808,561. However, instead of using an autoclave to provide heat and pressure, ultrasonic energy and mechanical pressure are applied to the reinforcing elements, thereby compressing the compressible material and inserting the reinforcing elements into the laminated composite structure. A somewhat more sophisticated system for practicing the hybrid method is taught in U.S. Pat. No. 5,800,672 to Boyce et al. All of the approaches that employ ultrasonic energy require bulky equipment and therefore are not well adapted for structures with complex shapes.

### SUMMARY OF THE INVENTION

The present invention seeks to overcome the difficulties associated with prior techniques of providing through-the-thickness reinforcement. As such, the following objects are important to the present invention.

An object of the present invention is to provide a method for delivering through-the-thickness reinforcement to a laminated composite material. The technique should not compromise in-plane mechanical properties because of the presence of stitching loops, nor should the technique require more than one-sided access to the laminated composite material. The method should be applicable to either dry fiber preforms or prepreg laminated materials. In addition, the method should be quick, portable, and not require bulky nor expensive equipment. The method should enable reinforcements to be inserted over a wide range of angles relative to the surface of the laminated composite material. The technique should be capable of being performed both by hand and under robotic control.

Another object of the invention is to provide a machine for practicing the method of insertion. The machine should be portable and easily adapted to deliver different types and sizes of reinforcement material.

A further object is to provide a method of making a reinforcing rod blank. The rod blank would comprise a plurality of connected reinforcing elements or rods. The rod blank would be capable of being used in the above mentioned machine for delivering through-the-thickness reinforcement.

Yet another object of the invention is to provide a medical implant for reinforcing bone or holding broken bone together while the bone heals. In addition to having structural fibers that add strength to the implant, either the implant's matrix contains healing and/or analgesic agents, or the implant contains space for containing healing and/or analgesic agents.

Another object is to provide an automotive tire that reduces the risk of delamination of the layers of the tire tread.

The above and numerous other objects are achieved through the use of an impulsive force to drive a rod through an uncured laminated composite material. The rod provides through-the-thickness reinforcement to the cured laminated composite material without substantially compromising in-plane mechanical properties. The impulsive force is preferably delivered with a machine that comprises a rod guide for guiding the reinforcing rod into the uncured composite material and a ram with a hardened tip for thrusting the rod along the rod guide. A blank of rods, suitable for use with the machine are made by placing a mixture of substantially unidirectional fiber material and uncured resin in a mold such that the fibers are generally aligned with the rod axes and then curing the mixture. In other embodiments rods are formed from a supply of continuous rod material. In these embodiments rods of finite length are cut from the continuous supply and then subsequently inserted into the uncured laminate material. An unique application of the rods is for use as a medical implant. The rods comprise structural fibers for strength and a matrix that contains healing and/or analgesic agents. Alternatively, the healing and/or analgesic agents are contained in spaces formed from a conventional matrix. A further application includes using through-the-thickness reinforcement in automotive tires to reinforce the interfaces between the various layers of tire material.

Other objects, features and advantages of the present invention will become more fully apparent from the following detailed description, the appended claims, and the accompanying drawings.

### BRIEF DESCRIPTION OF THE DRAWINGS

In the drawings, fibers are indicated in cross section by dots, and in side view by lines generally aligned with their respective yarns. Although the lines and dots representing the fibers are oriented substantially as they would be in a composite material, the number, density, and length of the fibers shown in the drawings are not necessarily representative of fibers in actual composite materials.

FIG. 1 shows yarns in a typical laminated composite material.

FIG. 2 shows a laminated composite material with a rod providing through-the-thickness reinforcement.

FIG. 3 illustrates a side view of a rod-inserting machine.

FIG. 4 shows a detailed side view of the magazine, the rod loader, the rod guide, the ram and ram actuator. The ram is extended.

FIG. 5 is similar to FIG. 4 except that the ram has retracted and the next rod is loaded into the rod guide.

FIG. 6 provides a perspective view of a ram.

FIG. 7 is a perspective view of a ram housing with internal ram chamber and rod guide.

FIG. 8 illustrates details of an alternate embodiment of the rod-inserting machine. Continuous rod material is cut to length to form individual finite-length rods.

FIG. 9 shows a rod-inserting machine under robotic control.

FIG. 10 is a cross-section view of top and bottom portions of a mold for making a rod blank.

FIG. 11 shows a bottom view of a rod blank with cross fibers.

FIG. 12 shows a cross-section of a rod blank. Although multiple fibers and cross fibers are shown, for clarity, only one of each is indicated.

FIG. 13 shows cross-sections of rods serving as medical implants. FIG. 13A shows a matrix of medicine. FIG. 13B has the conventional matrix and fibers in the central region with the medicine surrounding it. In FIG. 13C, the conventional matrix material and fibers form a C-shape with the medicine contained in the resulting cavity. FIG. 13D shows conventional matrix material in a U-shape with medicine in the remaining area. FIG. 13E shows conventional matrix material and fibers in an X-shape with medicine between the crossed sections.

FIG. 14 shows a cross sectional view of an automotive tire.

FIG. 15 illustrates the corner of an automotive tire with interlaminar reinforcement.

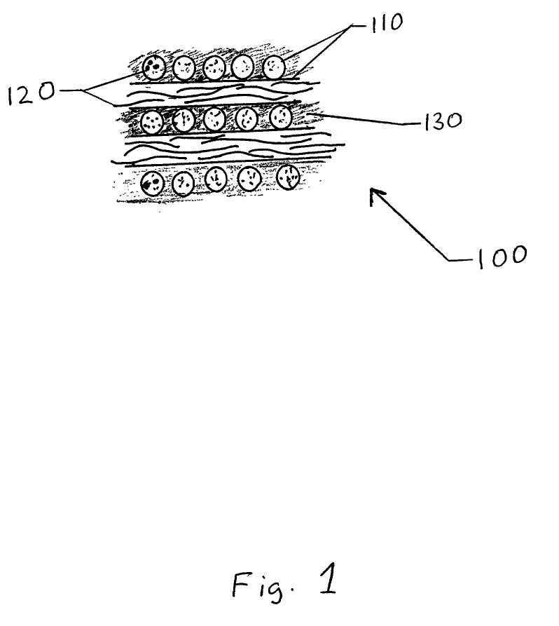

Reference numerals in the figures correspond to the following items:

100 laminated composite material

110 yarn

120 fiber

130 matrix

140 rod

150 rod blank

160 robot

170 ram

174 ram driving portion

176 ram driving portion face

180 ram tip

190 ram actuator

200 ram housing

210 ram chamber

220 rod guide

230 rod-guide notch

240 insertion slot

250 rod loader

254 rod-loader spring

256 rod-loader platen

260 magazine

270 continuous rod material

280 continuous rod material supplier

290 spool

300 cutter

310 robot

320 mold

322 bottom portion of mold

324 top portion of mold

326 gap between top and bottom portions of mold

328 semi-circular recesses in mold

329 cross fiber

330 medical implant

340 medicine

360 rod-inserting machine

370 handle

380 trigger

390 body

400 tire

410 tire tread

420 tire belt

430 tire bead

440 tire sidewall

450 tire body ply

### DETAILED DESCRIPTION OF THE PREFERRED EMBODIMENTS

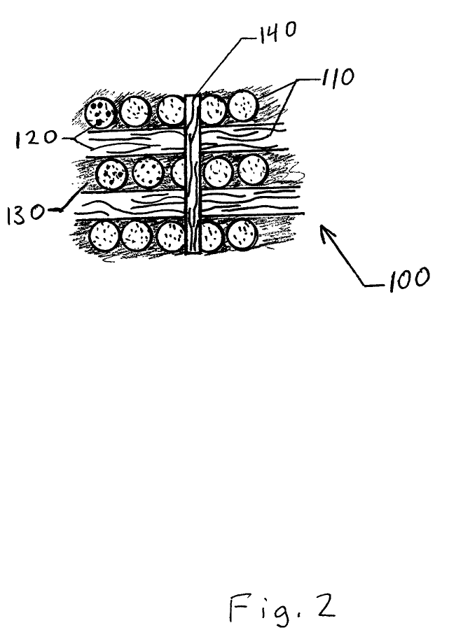

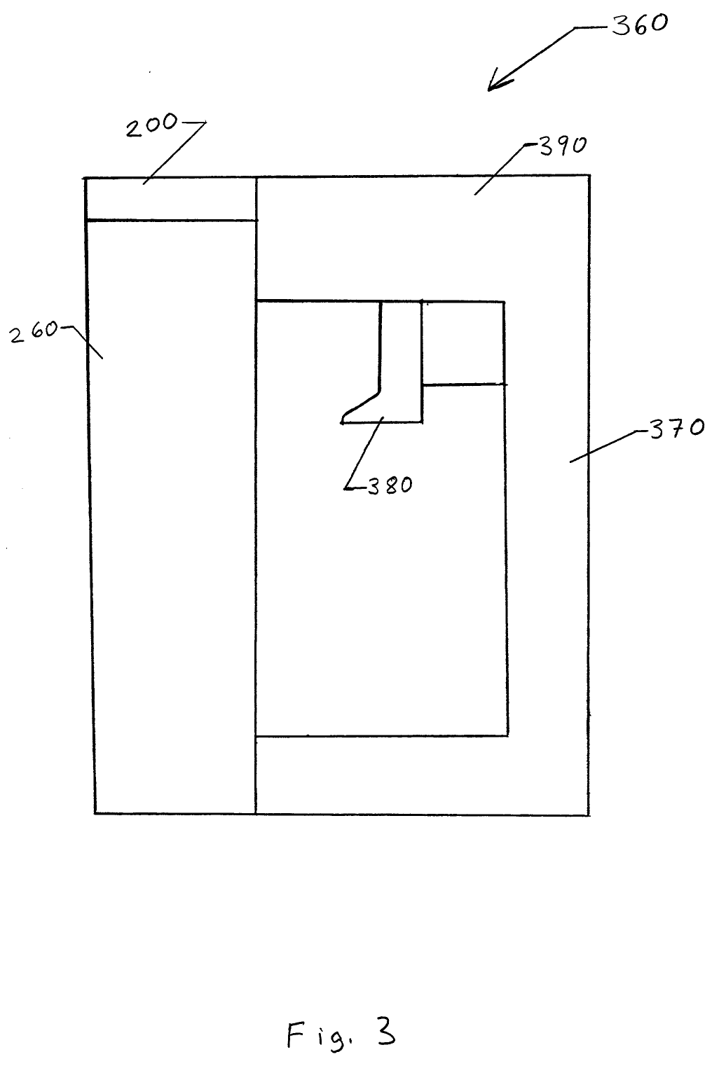

In FIG. 2, a rod 140 extends through the thickness of the laminated composite material 100. The presence of the rod 140 improves the interlaminar properties of the laminated composite material 100. Specifically, the presence of the rod 140 enhances damage tolerance, increases the ability of the material to transfer loads perpendicular to the plane of the plies, and helps retard crack growth. The diameter of the rod 140 is preferably small compared with the diameter of the yarn 110. For current uses the diameter of the rod 140 is most preferably between 0.005 inches and 0.030 inches, although the size is dependent on the specific use. The use of small rods 140 is preferred because the small size reduces the chance that the rod 140 will promote failure of the laminated composite material 100. Because failure of a composite structure generally is governed by the largest anomaly inherent in the composite structure, the inclusion of smaller-scale anomalies rarely has a detrimental effect. Typical large-scale anomalies in composite materials include fiber waviness, voids, and resin-rich regions. The scale of these anomalies tend to be at least the yarn diameter of the material, hence rods 140 with diameters less than the yarns 110 are less likely to adversely effect the laminated composite material 100. Although the use of larger rods degrades the mechanical properties, in some situations, the economies associated with using fewer but larger rods will outweigh the decreased mechanical performance.

A new technique for inserting through-the-thickness reinforcement into a laminated composite material 100 takes advantage of the fact that the strength of the laminated composite material 100 is not compromised substantially by localized damage to fibers, providing that the damaged region is small compared with the scale of largest inherent anomaly. In the new approach, rods 140 for providing through-the-thickness reinforcement are driven into the laminated composite material 100 with an impulsive force. Providing that each rod 140 has a diameter that is smaller than the largest scale anomaly inherent in the laminated composite material 100, the abrupt introduction of the rod 140 will have little detrimental effect on the structural properties of the final cured material. In fact the presence of the rod 140 will substantially increase the resistance of the laminated composite material 100 to interlaminar failure mechanisms.

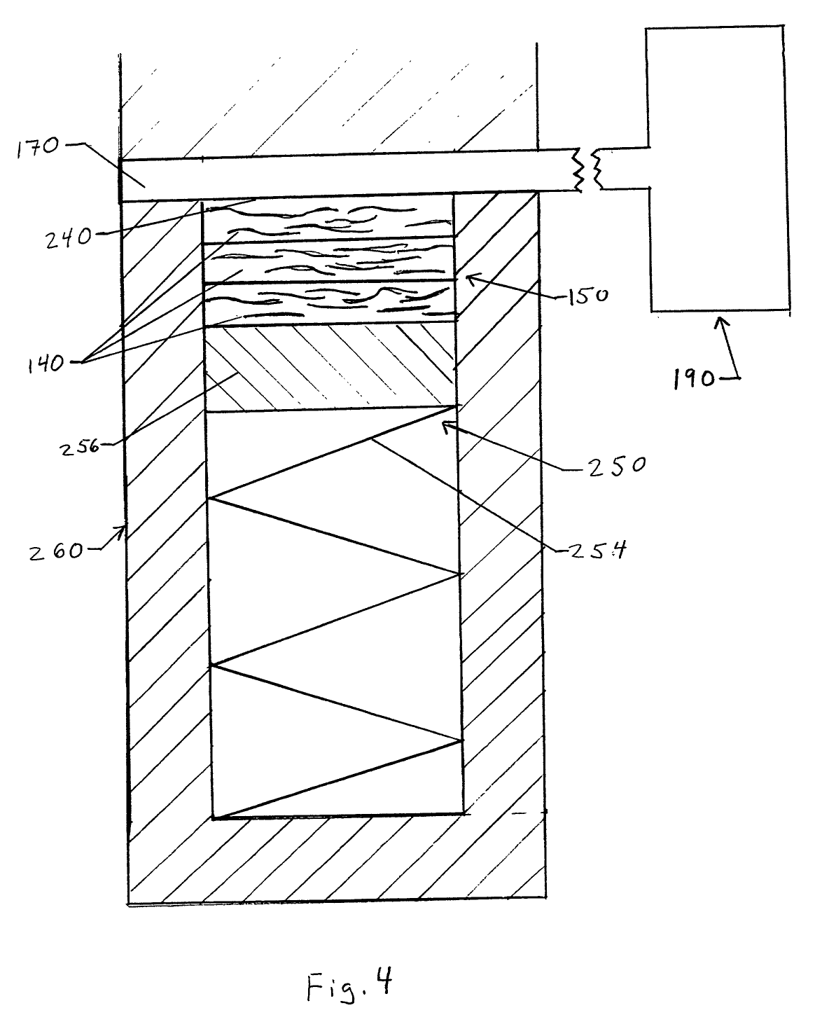

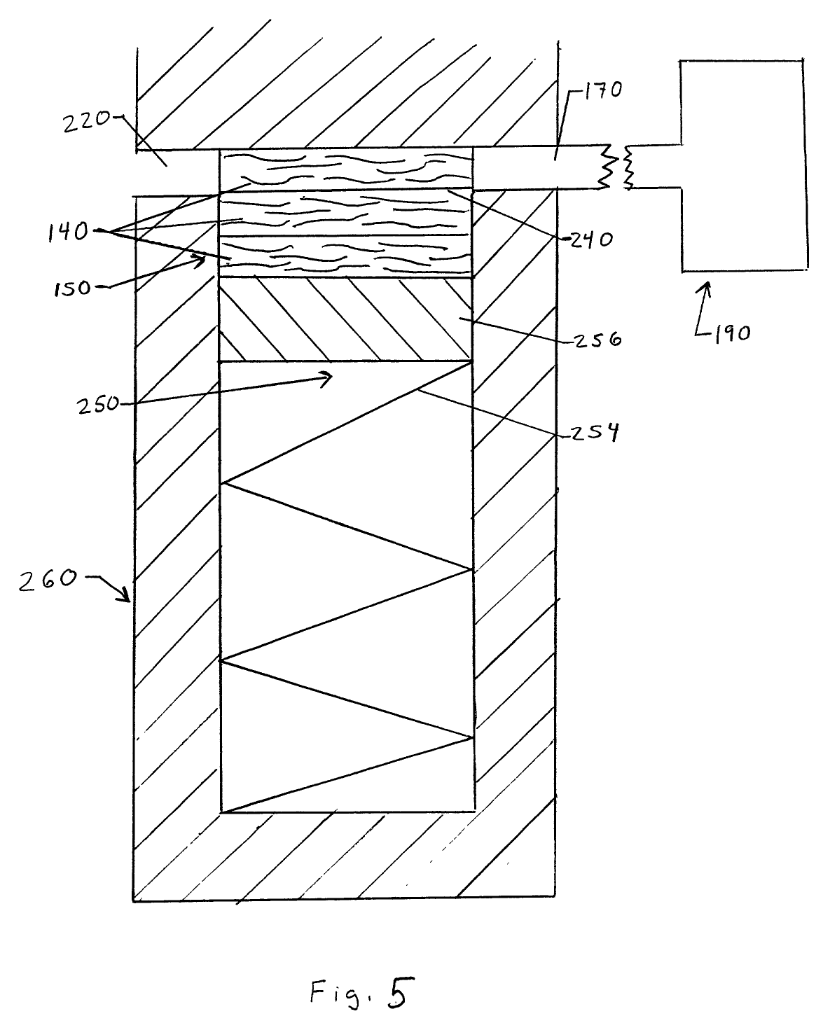

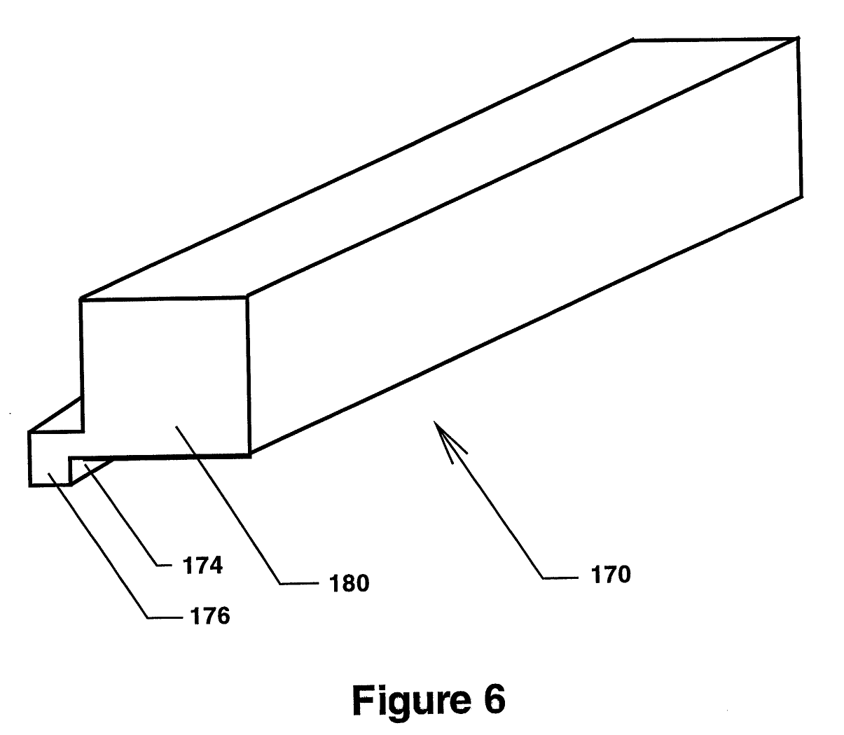

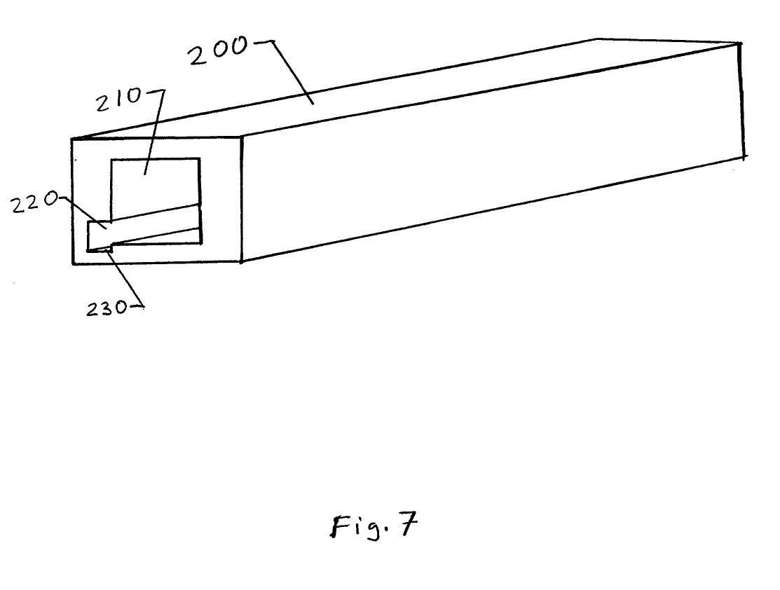

FIG. 3 shows a side view of a rod-inserting machine 360. The rod-inserting machine 360 is similar in many respects to a commercially available nail gun, such as the Stanley Bostitch Model Number BT35-2. Referring to FIGS. 4 and 5, a rod 140 stored in a magazine 260 is loaded into a rod guide 220, which is located interior to a ram housing 200. Upon actuation by a trigger 380, a ram actuator 190 in the body 390 thrusts a ram 170 with a hardened ram tip 180 along a ram chamber 210. Details of the ram are shown in FIG. 6 and the ram housing 200 with internal ram chamber 210 and rod guide 220 in FIG. 7. The ram 170 is an elongated member terminating at one end in a ram tip 180. The ram 170 has a ram driving portion 174 that is smaller in cross section than the rest of the ram 170. Only the ram driving portion face 176 actually contacts the rod 140. The bulk of the ram 170 provides strength and makes the ram 170 more resistant to buckling than the ram driving portion 174 alone would be. The shape of the ram 170 is a consequence of the shape of the ram chamber 210 and how the ram 170 attaches to the ram actuator 190. To enable convenient adaptability to differently sized rods, the preferred embodiment of the rod-inserting machine 360 allows the magazine 260, the ram housing 200, and the ram 170 to be easily replaced with components suited for differently sized rods 140. Preferably, each ram 170 has a cross section that is sized and shaped to fit a conventional ram actuator 190 at one end, and is sized and shaped with an appropriate ram driving portion 174 at the other end. The ram driving portion 174 need only extend along the ram length a distance sufficient to transfer the load from the ram driving portion 174 to the remainder of the ram 170 without creating excessive stress concentrations. Typically, a length of 3-5 times the largest linear dimension of the ram driving portion face 176 is sufficient to transfer the load without undue stress. Preferably, the rod guide 220 in the ram chamber 210 has close tolerances so that each rod 140 does not have much play as it is driven down the rod guide 220. The rod guide 220 must not be too small; otherwise the rod 140 will jam in the rod guide 220. The rod guide 220 preferably is not be too large, otherwise buckling and subsequent failure of the rod 140 is more likely to occur during rod insertion. As an example of the preferred tolerances, less than 0.005 inches of excess space is desired for a rod guide 220 designed for a rod 140 having a diameter between 0.020 inches and 0.025 inches. A rod-guide notch 230 is sized to prevent rod jamming and buckling. Although embodiments with any appropriately sized and shaped ram 170 are possible, preferably a large ram 170 is used. A large ram 170 tends to resist buckling and is more easily adapted to mate conveniently with standard ram actuators 190.

The ram driving portion face 176 of the ram tip 180 is preferably hardened to work in the rod-inserting machine 360. Experiments revealed that standard ram tips 180 are not hard enough to withstand the stresses resulting from driving the rods 140 into the laminated composite material 100. The small diameter rods 140 bear upon a small area of the ram tip 180, thereby creating large stresses. In addition, the fibers in the rod 140 generally have higher stiffness and hardness than the material of the ram 170. The impact of materials with disparate stiffnesses damages the less stiff material. Hardening the ram driving portion face 176 of the ram tip 180 reduces and/or eliminates this problem. Preferably the ram driving portion face 176 of the ram tip 180 is hardened by applying a silicon carbide or a diamond coating. Most preferably, the ram driving portion face 176 of the ram tip 180 is hardened by applying a diamond coating.

Referring back to FIG. 4, the operation of a preferred rod loader 250 is explained. The rod loader 250 comprises a rod-loader spring 254 that bears against the bottom of the interior of the magazine 260 and urges a rod-loader platen 256 upward. The three remaining rods 140 of a rod blank 150 are shown above the rod-loader platen 256. The rod blank 150 is a group of rods 140 temporarily held together for ease of handling. Although in some embodiments individual rods 140 are loaded into the magazine 260, the rod blank 150 is easier to handle and therefore is preferred. More details of the rod blank 150 are given later. The rod-loader platen 256 pushes upward against the rod blank 150. In FIG. 4, the ram 170 is still extended in the rod guide 220, as it would be just after driving the previous rod 140 and before being retracted by the ram actuator 190. The presence of the ram 170 in the rod guide 220 prevents the rod loader 250 from inserting the next rod 140 into the rod guide 220. In FIG. 5, the ram 170 is retracted and the next rod 140 is pushed upward through an insertion slot 240 and into the rod guide 220. Actuation of the ram actuator 190 thrusts the ram 170 forward again. The force of the ram 170 shears the rod 140 from the rod blank 150 and drives the rod 140 through the rod guide 220 and into the laminated composite material 100.

Because 60 to 100 rods per square inch are typically required to achieve damage-tolerant structures, other embodiments of the rod-inserting machine 360 insert multiple rods per insertion or ram actuation cycle.

To accomodate more rods in a single rod blank, in a further embodiment (not shown), the linear magazine is replaced with a circular magazine where the rod blank is rolled in a spiral around a core. Each time a rod is inserted, the rolled up blank rotates, advancing the end rod into the rod guide. Alternate embodiments feed multiple rod blanks simultaneously into multiple rod guides for simultaneous insertions of the rods.

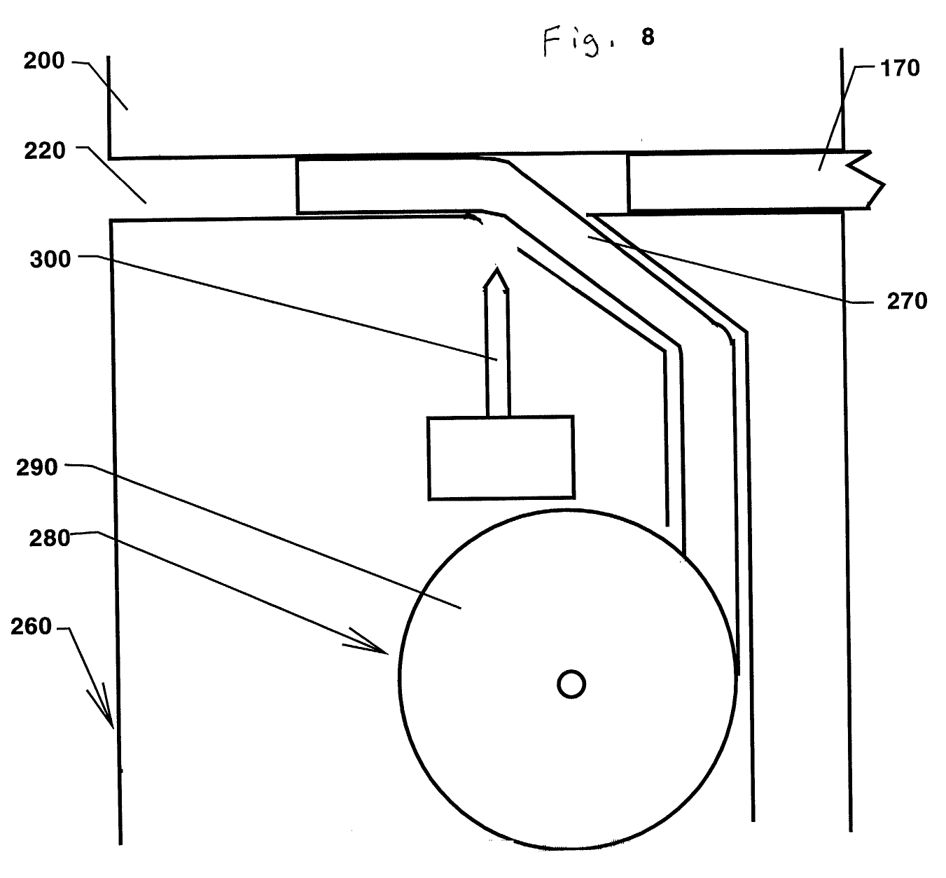

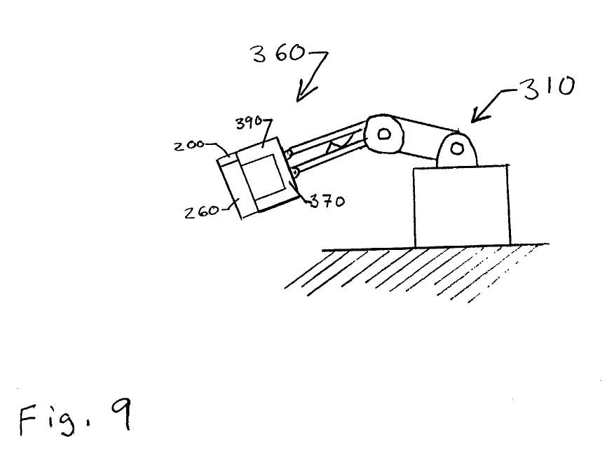

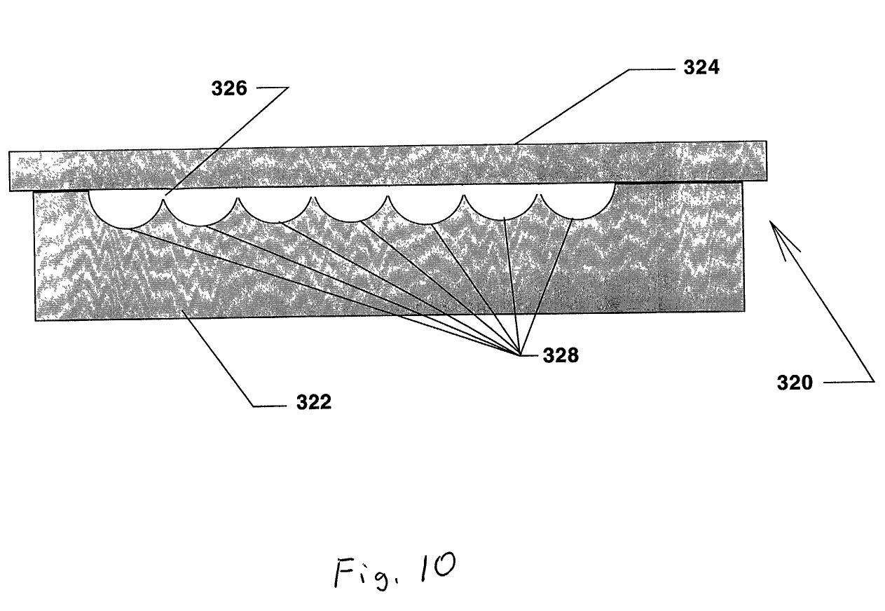

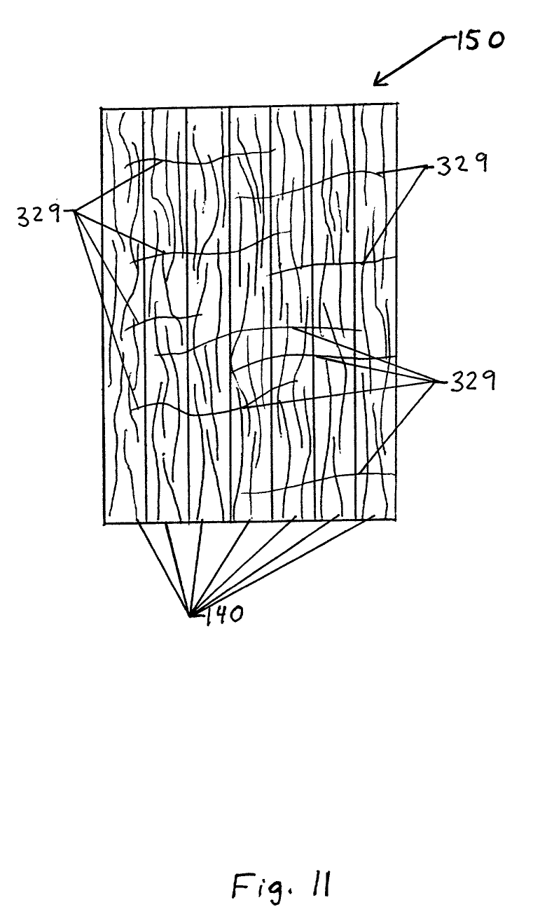

Another embodiment is shown in FIG. 8. Instead of storing discrete rods 140 in the magazine 260, continuous rod material 270 is stored on a continuous rod material supplier 280, which is a spool 290 in this particular embodiment. In other embodiments, other types of continuous rod material suppliers 290 are used. The continuous rod material 270 is fed into the rod guide 220. A cutter 300 cuts the continuous rod material 270 into a rod 140 of finite length and then retracts. The continuous rod material 270 is sufficiently elastic so that the portion cut returns to a substantially straight configuration after being cut. The ram 170 then drives the rod 140 down the rod guide 220 and into the uncured laminated material. Preferably the motion of the cutter 300 is electrically or pneumatically actuated. Also preferably, the continuous rod material 270 is made by a conventional pultrusion process.

FIG. 9 shows the rod-inserting machine 360 being controlled by a robot 310. When under robotic control, triggering is preferably done electronically, hence no mechanical trigger 380 is needed.

Insertion of the rod 140 at non-normal incidence to the surface of the laminated composite material 100 is easily accomplished by tilting the rod-inserting machine 360. Embodiments of the rod-inserting machine 360 with wedges to tilt the rod-inserting machine 360 provide a means of consistantly inserting rods 140 at a specific angle. Wedges are particularly helpful when the rod-inserting machine 360 is manually operated, but are generally unnecessary when the rod-inserting machine 360 is used in conjunction with a robot.

Rods 140 are made from any appropriate material. Preferably metal or composite materials are used. Metallic rod blanks 150 are formed in a similar manner as commercially available metallic brads are produced.

Although the diameter of the rods 140 most preferably ranges between 0.005 and 0.030 inches, larger diameter rods 140 are useful on larger structures, especially in cases in which coarse yarns are used in the laminated composite material. Similarly, although the length of each rod 140 is typically between 0.005 and 1.0 inches, longer rods 140 are appropriate for large structures.

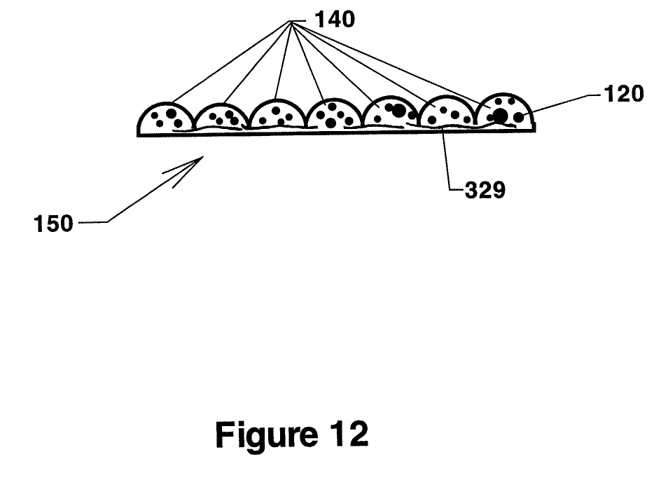

One method for making rod blanks 150 of composite material includes placing unidirectional prepreg material in a mold 320 such that the fiber orientation of the prepreg is aligned with the axis of the rods 140. FIG. 10 shows bottom 322 and top 324 portions of a mold 320. In this embodiment, the bottom portion 322 of the mold 320 has approximately semi-circular recesses 328. Each semi-circular recess 328 will contain material for a single rod 140. The top portion 324 of the mold 320 is flat. A small gap 326 exists between the flat top portion 324 and the sections that divide the semi-circular recesses 328. The gap 326 permits some prepreg material to join adjacent semi-circular recesses 328, thereby joining the resultant rods 140. Preferably a relatively small number of additional fibers 329 are oriented perpendicular to the rods 140 in the gap 326. The resultant rod blank 150 is held together better, thereby facilitating handling of the rod blank. After placing the material in the mold 320, the material is cured. A bottom view of the finished rod blank 150 is shown in FIG. 11. A cross-sectional view of the finished rod blank 150 is shown in FIG. 12. An alternate embodiment employs dry fibers and a separate resin in place of prepreg. The remainder of the process and the resultant product are essentially the same. In another embodiment, the surface of the resultant rods is slightly roughened to improve adhesion between the rod 140 and the laminated composite material 100. The roughening is performed either after curing the rod blank 150, or by employing a mold with spaced indentations or a coarse inner surface. However, generally the roughening is not required. The cross fibers 329 are explicitly indicated. In the preferred embodiments, each rod blank is approximately 4 to 6 inches in length, resulting in approximately 200 to 800 rods per blank. Alternate embodiments with differently shaped and sized molds are also appropriate, depending upon the particular application.

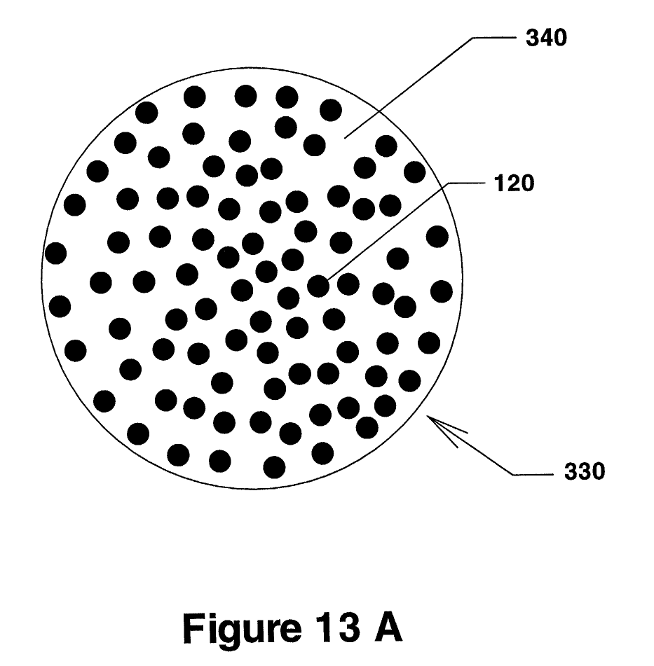

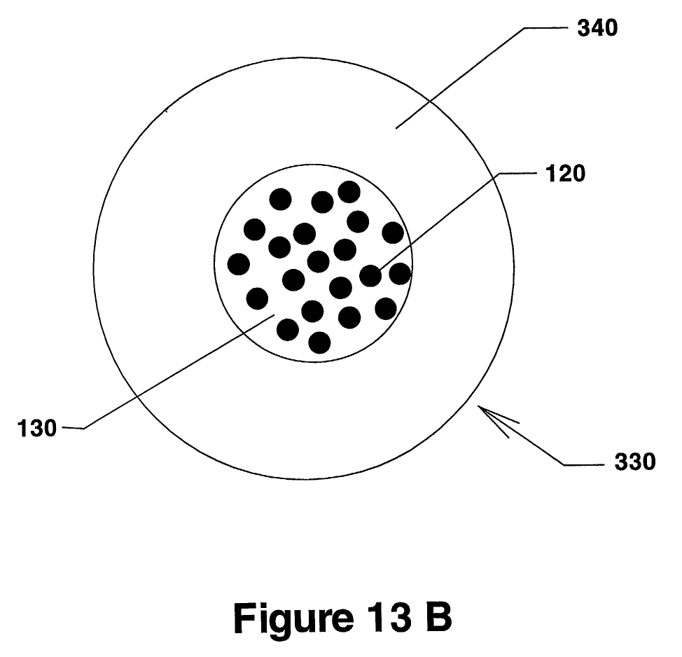

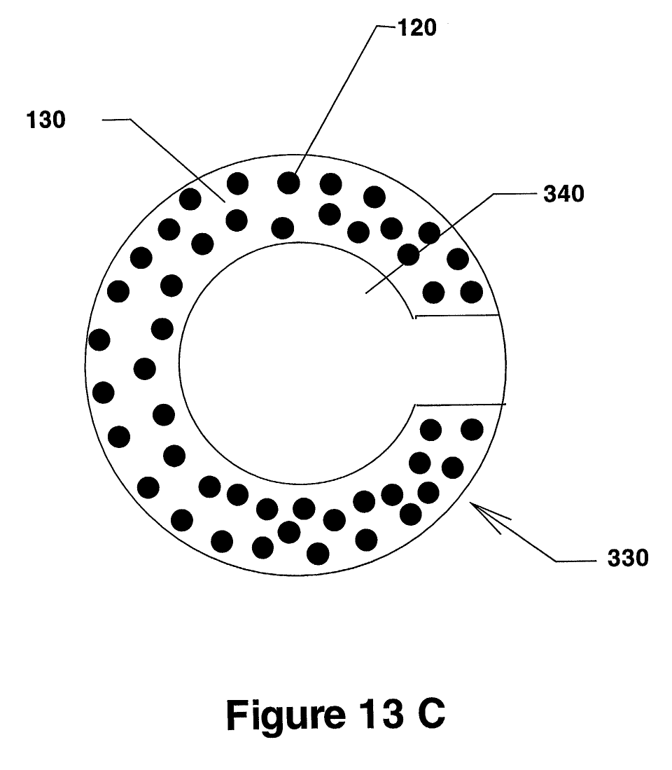

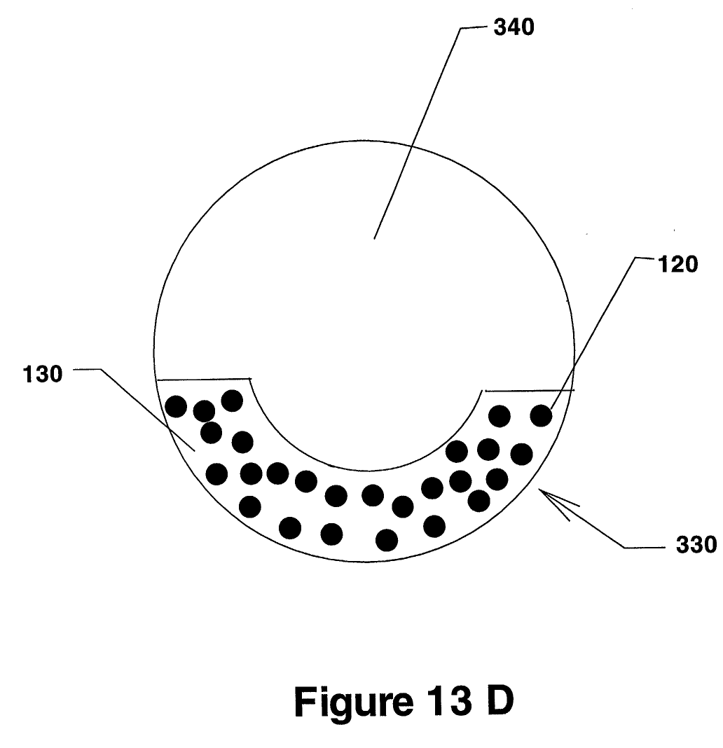

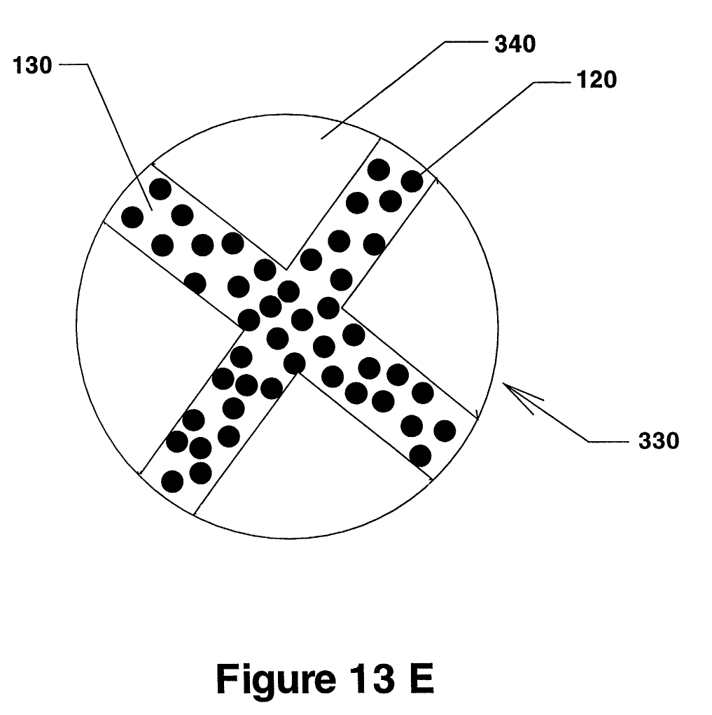

Medical implants 330, as shown in FIGS. 13A through 13D, made from the rods 140 can be used as reinforcements to support broken bones and facilitate proper bone alignment while simultaneously providing a medical delivery vehicle for analgesics and healing agents directly to the damaged area. The term medicine is used to refer to any appropriate combination of analgesic and healing agents. As shown in FIG. 13A, the matrix 130 of the medical implant 330 could be comprised of solidified medicine 340 that dissolves in a time-release fashion, dispensing the medicine 340 to the damaged area as it dissolves. The fibers 120 would remain embedded in the bone after the broken bone reattaches. In one embodiment, the medicine is formulated as a solid at room temperature, but melts at body temperature. To aid in insertion, the stiffness of the medicine matrix is increased by decreasing the temperature of the implant 330 prior to insertion. Because the medicine does not always provide an appropriate matrix material for the fibers 120, in other embodiments a conventional matrix material, as for example a structural polymer, is used to form a section of the implant 330, the balance of the implant 330 being filled with medicine 340. In FIG. 13B, the conventional matrix material 130 is used in a core region, and the medicine 340 encircles the core region. A C-shaped void for the medicine 340 is shown in FIG. 13C. In FIG. 13D, a U-shaped conventional matrix 130 is used, with the medicine 340 filling the remaining area. An X-shaped region of conventional matrix 130 with the gaps between the crossed regions filled with medicine 340 is illustrated in FIG. 13E. In the embodiments of FIGS. 13B, 13C, 13D and 13E, the medicine fills the spaces in the implant 330 that is not occupied by the fibers 120 nor by the matrix 130.

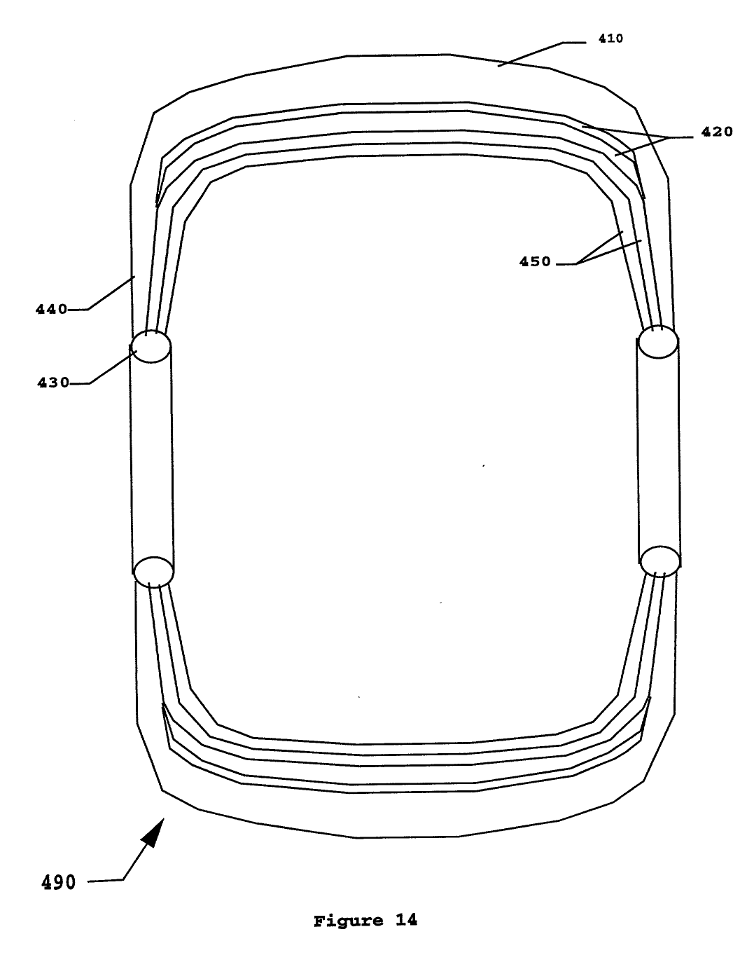

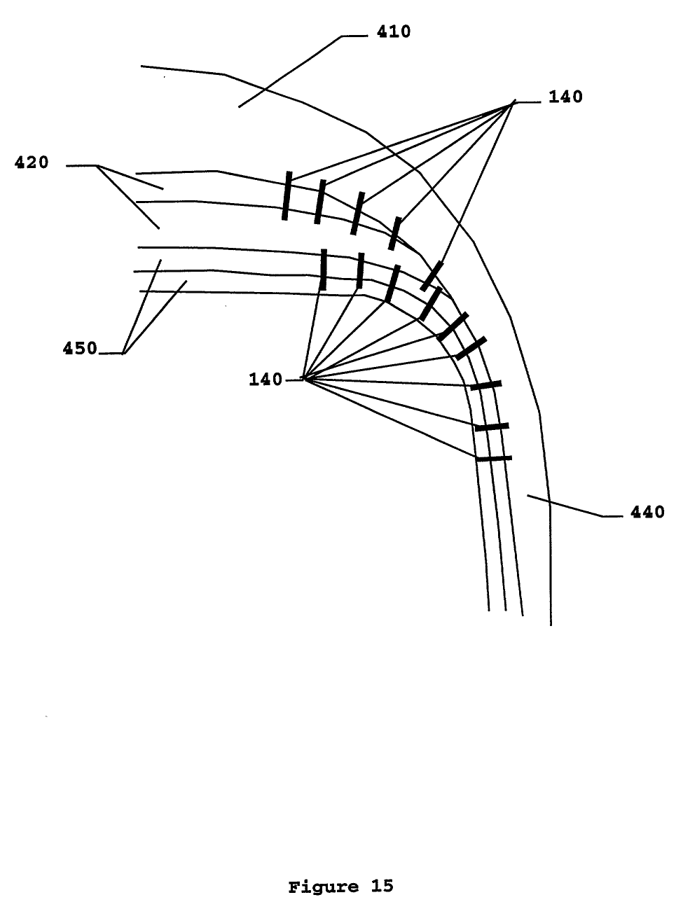

Interlaminar reinforcement is also applicable to improved automotive tires. In particular, run-flat tires are designed to be usable even after experiencing a loss of tire air pressure. However, run-flat tires typically have severe speed and drive-duration limitations. After losing air pressure, run-flat tires flex more than usual, thereby increasing heat production. The heating decreases interlaminar strength between the layers of the tire, leading to delamination failures. FIG. 14 illustrates a cross section of a typical tire 490. The outermost layer of the tire is referred to as the tire outer wall. The tire outer wall is comprised of two portions: the tire tread 410 on the outer circumference, and the tire sidewalls 440 on the side portions of the tire outer wall. The tire tread 410 is typically thicker than the tire sidewall 440. Proximal to the tire tread 410 are one or more tire belts 420. Preferably each tire belt 420 is made of steel although other types of puncture-resistant material are usable. Proximal to the tire belts 420 are tire body plies 450. On the tire sidewall 440, where the tire belts 420 are not required, the tire body plies 450 are overlain with the tire sidewall 440 portion of the tire outer wall. Tire beads 430 seal the tire 490 to a wheel rim thereby enabling elevated air pressure to be maintained inside the tire. Delamination failures typically occur at geometric discontinuities, such as layer discontinuities and changes in the tire geometry. The junction of the tire tread 410 and the tire sidewall 440 is such an area. The tire belts 420 typically do not continue along the sidewall, therefore the bond between the tire body plies 450 and the tire belts 420 ends and new bonds begin, for instance, between the tire body plies 450 and the tire sidewall 440. Referring now to FIG. 15, interlaminar reinforcement, such as the introduction of rods 140 through the various layers of the tire, greatly reduces the risk of delamination failure. Rods 140 through the interface of the tire tread 410 and the tire belt or belts 420 are particularly helpful, as are rods 140 through the interface of the tire belt or belts 420 and the tire body ply or plies 450. Further reinforcement involving rods 140 through the interface of the tire body ply or plies 450 and the tire sidewall 440 are also useful. Although any appropriate type of interlaminar reinforcement is usable, the rods 140 described herein are preferred. Most preferably, composite rods 140 are used. The application of the method for inserting the rods 140 described herein is well suited for the tires. The compound curvature of the tire and the restriction to one-sided access to the plies does not present any special problems.

Compared with prior methods for inserting through-the-thickness reinforcements, the use of an impulsive force to drive rods into uncured laminated composite material is fast, inexpensive, and rapidly adaptable to different shapes and configurations of the underlying composite material. The method of insertion is straightforward to use on complex structures. Only one-sided access to the composite material is required, hence the reinforcement can be inserted while the composite material is lying on its support tool, thereby eliminating the need to provide custom tooling, as is the case for stitching. Damage to the composite material during the insertion process is limited to the very near vicinity of the inserted rod 140. Such limited damage is in marked contrast to stitching and tufting processes in which the damaged area extends to the diameter of the needle, which is typically much larger than the inserted reinforcement.

Although the description above contains specific examples, these should not be construed as limiting the scope of the invention, but as merely providing illustrations of some of the presently preferred embodiments. Thus the scope of the invention should be determined by the appended claims and their legal equivalents, rather than by the examples given.

What is claimed is:

1. A method for inserting through-the-thickness reinforcement into an uncured laminated composite material, comprising the step of:
driving a rod into the uncured laminated composite material with an impulsive force.

2. A method for inserting through-the-thickness reinforcement into an uncured laminated composite material according to claim 1 wherein the rod is a cured composite material.

3. A method for inserting through-the-thickness reinforcement into an uncured laminated composite material according to claim 1 wherein the rod is metallic.

4. A method for inserting through-the-thickness reinforcement into an uncured laminated composite material according to claim 1, wherein the rod has a diameter that is smaller than the scale of the largest anomaly of the uncured laminated composite material.

5. A method for inserting through-the-thickness reinforcement into an uncured laminated composite material according to claim 1, further comprising the step of:
shearing the rod from a rod blank.

6. A method for inserting through-the-thickness reinforcement into an uncured laminated composite material according to claim 1 wherein prior to said driving step, the method comprises:
robotically positioning the rod.

7. A method for inserting through-the-thickness reinforcement into an uncured laminated composite material according to claim 1 wherein the temperature of the uncured laminated composite material remains substantially at the ambient temperature.

8. A method for inserting through-the-thickness reinforcement into an uncured laminated composite material according to claim 1 wherein said driving step is accomplished by a ram thrusting the rod.

9. A method for inserting through-the-thickness reinforcement into an uncured laminated composite material according to claim 8 wherein the ram is hydraulically propelled.

10. A method for inserting through-the-thickness reinforcement into an uncured laminated composite material according to claim 8 wherein the ram is electrically propelled.

11. A method for inserting through-the-thickness reinforcement into an uncured laminated composite material according to claim 8 wherein the ram is magnetically propelled.

12. A method for inserting through-the-thickness reinforcement into an uncured laminated composite material according to claim 8 wherein the ram is pneumatically propelled.

13. A method for inserting through-the-thickness reinforcement into an uncured laminated composite material according to claim 12 further comprising the step of:
shearing the rod from a rod blank.

14. A method for inserting through-the-thickness reinforcement into an uncured laminated composite material according to claim 13 wherein prior to said driving step, the method comprises:
robotically positioning the rod.

15. A machine for inserting a rod into an uncured laminated composite material, comprising:
a rod guide;
a ram for thrusting the rod along said rod guide, said ram having a hardened driving portion face; and
a ram actuator for propelling said ram.

16. A machine for inserting a rod into an uncured laminated composite material according to claim 15 wherein the hardened driving portion face of said ram has been hardened with a silicon carbide coating.

17. A machine for inserting a rod into an uncured laminated composite material according to claim 15 wherein the hardened driving portion face of said ram has been hardened with a diamond coating.

18. A machine for inserting a rod into an uncured laminated composite material according to claim 15, further comprising a ram housing, said ram housing having internal walls that define a ram chamber through which said ram slides, said rod guide being included inside said ram chamber.

19. A machine for inserting a rod into an uncured laminated composite material according to claim 18, further comprising:
a magazine for storing rods, said magazine being in operable relationship with said ram housing; and
a rod loader for delivering rods from said magazine into said ram chamber.

20. A machine for inserting a rod into an uncured laminated composite material according to claim 18, further comprising:
a magazine in operable relationship with said ram housing;
a continuous rod material supplier in said magazine for supplying continuous rod material to be cut; and
a cutter in operable relationship with said continuous rod supplier, said cutter being positioned to cut the continuous rod material to form rods.

21. A machine for inserting a rod into an uncured laminated composite material according to claim 15 wherein said ram actuator is pneumatically actuated.

22. A machine for inserting a rod into an uncured laminated composite material according to claim 15 wherein said ram actuator is hydraulically actuated.

23. A machine for inserting a rod into an uncured laminated composite material according to claim 15 wherein said ram actuator is electrically actuated.

24. A machine for inserting a rod into an uncured laminated composite material according to claim 15 wherein said ram actuator is magnetically actuated.

25. A machine for inserting a rod into an uncured laminated composite material according to claim 15, further comprising a robot for robotically controlling placement of the rod.

26. A method of making composite rod blanks, comprising the steps of:
placing a mixture of essentially unidirectional fiber material and uncured resin into a mold for a plurality of connected rods, the fiber orientation being substantially aligned with the length of each rod; and
curing the mixture.

27. A method of making composite rod blanks according to claim 26 wherein the mixture of essentially unidirectional fiber material and uncured resin is prepreg material.

28. A method of making composite rod blanks according to claim 26, further comprising the step of:
positioning a relatively small number of fibers perpendicular to the length of each rod and across the boundary of adjacent rods.

29. A composite rod blank made by the method of claim 26.

30. A medical implant, comprising:
fibers arranged to provide strength to the implant;
a matrix supporting said fibers; and
time-releasable medicine filling spaces in the medical implant not occupied by said fibers and matrix.

31. An automotive tire, comprising:
a tire outer wall having a tire tread on its outer circumference and tire sidewalls on the side portions;
a tire belt laid proximal to said tire tread;
a tire body ply laid proximal to said tire tread and said tire sidewalls;
a plurality of rods inserted through the interface of said tire body ply and said tire belt;
a plurality of rods inserted through the interface of said tire tread and said tire belt; and
a plurality of rods inserted through the interface of said tire sidewall and said tire body ply.
